(19) United States
(12) Patent Application Publication
(10) Pub. No.: US 2004/0054631 A1
(43) Pub. Date: Mar. 18, 2004

(54) Method for checking postage stamps on letters and parcels

(76) Inventors: Jurgen Lang, Bergisch Gladbach (DE); Bernd Meyer, Konigswinter (DE)

Correspondence Address: CONNOLLY BOVE LODGE & HUTZ, LLP, P O BOX 2207, WILMINGTON, DE, 19899, US

(21) Appl. No.: 10/399,244

(22) PCT Filed: Oct. 16, 2001
(86) PCT No.: PCT/DE01/03893

(30) Foreign Application Priority Data
Oct. 18, 2000 (DE) 100518184

(51) Int. Cl. G06F 17/60; H04K 1/00

(52) U.S. Cl. 705/62

(57) ABSTRACT

The invention relates to a method for checking postage stamps on letters and parcels, at a checkpoint. Said checkpoint deciphers the identity and authenticity of a customer system having generated the production of the stamp by decoding cryptographic security elements originating from a trusted certification point. According to the invention, this method is carried out in such a way that means contained in the checking unit determine a key for which the probability of having been used to encode the data at the certification point is particularly high.

### DESCRIPTION

The invention relates to a method in which postage indicia applied onto mailpieces are checked in a checking station, whereby the checking station, by decrypting cryptographic security elements stemming from a reliable certification station, deciphers the identity and authenticity of a customer system that has generated the postage indicia.

It is a known procedure to provide mailpieces with individualized, encrypted postage indicia.

Even though the keys in the encryption methods put forward have a key length that makes decryption impossible, it is also necessary to avoid the risk that a member of a small group of people who are informed about the content of the key might use this information about the key without authorization or might pass it on to someone else.

Therefore, it should be possible for the key used for the encryption to be replaced upon demand by a system or else after a certain period of time has elapsed.

Since a personal transfer of the new key is not suitable in systems intended for mass use because of the complexity associated with such a procedure, the replacement of a key needs to be largely automated.

A solution for the problem of replacing the key on an as-needed basis is described in European Patent Application EP 0 854 444 A2. This method entails the use of a pointer algorithm for finding pointers, whereby a pointer is used that points to a data address containing information about a key that is to be selected. A requisite feature of this method is a fixed number of keys that are laid down through the selection of the pointer.

The invention is based on the objective of creating a method for checking postage indicia applied onto mailpieces which combines a high degree of security against manipulation with a fast possibility of checking the postage indicia in the checking station.

According to the invention, this objective is achieved in that a means present in the checking station selects a key for which the probability that it was used for the encryption of the data in the certification station is especially high.

The invention makes it possible to quickly and reliably decipher cryptographic information present in a postage indicium without the use of a pointer.

This increases the data security by several orders of magnitude. To start with, there is no pointer whose functionality can be determined with fraudulent intent by an external data routine; secondly, it is possible to use any desired number of keys.

This method is especially secure when all of the data on the postage indicium is configured in such a way that it does not contain any information about a key that is to be used.

When the cryptographic key is changed, especially by the certification station, any transfer of information about the key to be checked is avoided.

If such a key change takes place spontaneously and if there is an overlapping period of time entailing the use of several keys, it can be avoided that the accompanying information that is incorporated by the customer system into the postage indicium provides a precise documentation of the key change.

It is especially advantageous for the means present in the checking station to check whether a decryption with the most probable key succeeded.

Advantageously, in case the decryption did not succeed, a decryption is carried out with another key.

Forged postage indicia are discovered in an especially simple and advantageous embodiment of the method in that a postage indicium with which a decryption fails using keys whose correctness together reaches a prescribed probability is marked as forged.

Further advantages, special features and practical refinements can be gleaned from the subordinate claims and from the following presentation of preferred embodiments of the invention with reference to the drawings.

The drawings show the following:

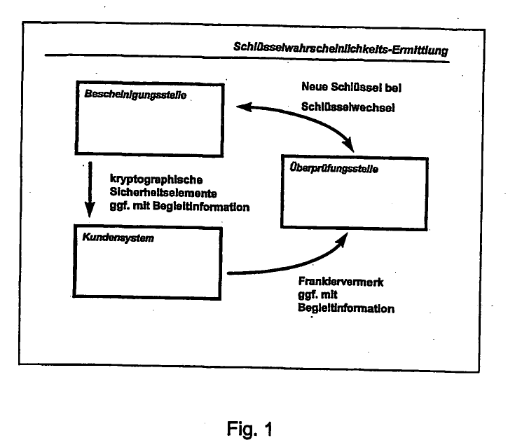

FIG. 1—a schematic diagram of a key checking method and

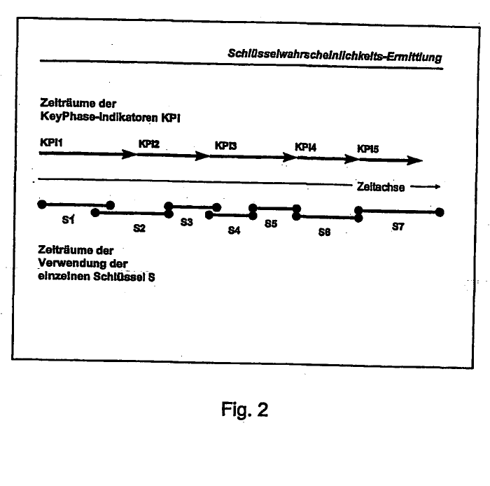

FIG. 2—a schematic diagram of a time-dependence of the use of the key phase indicators according to the invention.

FIG. 1 shows the principle of a key checking method. A key change can be agreed upon between the certification station and the checking station. Preferably, this key change takes place independent of other cryptographic security elements that can be exchanged between the certification station and the customer system.

Preferred embodiments of the checking method according to the invention are presented below, whereby in the checking station for the decryption of security elements, a key is ascertained for which the probability that it was used to carry out the encryption of the data is especially high. The security elements had been previously encrypted by a certification station and had been transmitted to a customer system which, in turn, incorporated them into the postage indicium.

It is especially advantageous to carry out the method in such a way that a customer system is rendered able to generate postage indicia that can be checked in a checking station for manipulation or forgery, and for this purpose, these postage indicia have to contain cryptographic security elements that stem at least in part from a reliable source. From the vantage point of the checking station, the certification station is such a reliable source.

Prior to generating the postage indicia in the customer system, the certification station sends the cryptographic security elements encrypted in such a way that only the checking station can decrypt them. This calls for corresponding keys for encrypting and decrypting on the part of the certification station and the checking station.

Simultaneously with the exchange of the cryptographic security elements, accompanying information can optionally be exchanged between the certification station and the customer system that indicates the point in time of the generation of the accompanying information and, if applicable, of the cryptographic security elements. This accompanying information, which is called the key phase indicator in this particular method, can be further conveyed in the postage indicium to the checking station and can render the latter able to ascertain with high probability a corresponding key for decrypting the cryptographic security elements.

In the certification station, the postage indicium is now examined for manipulation or forgery in that several possible keys for the decryption of the cryptographic security elements are kept ready. In order to ensure a high checking speed, something which is indispensable for the automated checking of postage indicia, a selection is made, from the array of possible keys, of those keys for which the probability that they were used for the encryption of the data in the certification station is especially high.

In order to ascertain the most probable key, at least one of the sequences of the process steps listed below is carried out:

1)

If accompanying information indicating the point in time when the cryptographic security elements were created is present in the postage indicium in the form of a key phase indicator, then the keys used during this period of time are first checked in a given order, for example, chronological, as the most probable key. Subsequently, the less probable keys which were also used in adjacent periods of time with adjacent key phase indicators are then checked. Since other keys are even more improbable, the checking for another key beyond a certain (low) probability can finally be terminated and the postage indicium can be considered to be invalid.

2)

If no accompanying information is present, then the checking station proceeds as follows: in counter-chronological direction, namely, from the currently used key phase indicator backwards into the past, the checking station assigns a key phase indicator. This optimizes the finding of the corresponding key.

FIG. 2 shows a preferred coordination of periods of time for key phase indicators and periods of time for the use of keys. It should be noted that, through the introduction of the key phase indicators, especially also the overlapping periods of time in the case of key changes (which are shown in exaggerated form in the figure), can be covered.

A postage indicium that contains the key phase indicator KPI3 as accompanying information or that is assigned this key phase indicator by the checking station due to the absence of accompanying information is first decrypted with the key S4, since it is highly probable that this key, besides key S5, was used during this period of time and the key S4 was used chronologically before the key S5. If the decryption with the key S4 fails, then the key S5 is used. If the decryption also fails with the key S5, then the less probable key S3 is used for the decryption. If this also fails, then a decryption with the even less probable key S6 is tried. Subsequently, the decryption is finally terminated due to insufficient probability that other keys were used and the postage indicium is considered as being invalid and perhaps as having been forged.

1. A method in which postage indicia applied onto mailpieces are checked in a checking station, whereby the checking station, by decrypting cryptographic security elements stemming from a reliable certification station, deciphers the identity and authenticity of a customer system that has generated the postage indicia,
characterized in that a means present in the checking station selects a key for which the probability that it was used for the encryption of the data in the certification station is especially high.

2. The method according to claim 1, characterized in that a checking procedure is carried out to check whether a decryption with the most probable key succeeded.

3. The method according to claim 2, characterized in that, in case the decryption did not succeed, a decryption is carried out with another key.

4. The method according to one or more of claims 1 to 3, characterized in that a postage indicium with which a decryption fails using keys whose correctness together reaches a prescribed probability is marked as forged.

5. The method according to one or more of claims 1 to 3, characterized in that a postage indicium is marked as forged if its decryption did not succeed with keys of which at least one, with a probability of 95% at the minimum, is correct.
